(19) United States
(12) Patent Application Publication
(10) Pub. No.: US 2005/0036881 A1
(43) Pub. Date: Feb. 17, 2005

(54) Feeder device, feeded station and method of feeding

(76) Inventors: Bengt Eriksson, Morrum (SE); Brodde Bengtsson, Jamshog (SE)

Correspondence Address: VENABLE, BAETJER, HOWARD AND CIVILETTI, LLP, P.O. BOX 34385, WASHINGTON, DC, 20043-9998, US

(21) Appl. No.: 10/481,266

(22) PCT Filed: Jun. 14, 2002
(86) PCT No.: PCT/SE02/01148

(30) Foreign Application Priority Data
Jun. 20, 2001 (SE) 0102212.8

(51) Int. Cl. B65G 59/00

(52) U.S. Cl. 414/795.4

(57) ABSTRACT

A device for continuous and individual feeding of sheets from a stack to a depositon site comprises gripping members (15) for grasping and hoding the sheets, and a movement device for displacing the gripping members (15) between the stack and the deposition site. The movement device displays two arms (12, 13), which are provided with the gripping members (15). The arms (12, 13) are pivotal about a vertical pivot axis (14) and are movable therealong in the verical direction to positions (33) for both depositing and picking a sheet. Further, the one arm (12, 13) may be pivoted past the other (12, 13). A feeder station for feeding in accordance with the foregoing includes at least one sheet stack, a deposition site and a feeder device. The stack and the deposition site are disposed on a common arc of a circle, and the feeder device has a pivotal arm (12, 13) which is provided with gripping members (15). A method of feeding in accordance with the foregoing in which use is made of a movement device as disclosed above. One gripping member (15) discharges a sheet when the second gripping member grasps a sheet on the stack. Thereafter, the gripping members (15) are lifted and pivoted so that they pass each other, whereupon they are both lowered, so that the method may be repeated.

### TECHNICAL FIELD

The present invention relates to a device for the continuous and individual feeding of sheet metal plates from a stack of sheets to a deposition site, and comprising a movement device for displacement of gripping members which are designed to individually grasp and hold the sheets, between the sheet stack and the deposition site, and back.

The present invention further relates to a feeder station for the continuous and individual discharge of sheets and comprising at least one, but preferably two stacks of sheets which are to be fed, a deposition site for sheets and a feeder device for the individual picking of sheets and deposition thereof at the deposition site.

Finally, the present invention relates to a method of continuous and individual feeding of sheets from a stack of sheets to a deposition site, use being made of a movement device by means of which gripping members designed to individually grasp and hold the sheets move them from the stack to the deposition site.

### BACKGROUND ART

In the mechanisation of presses or press lines, the individual sheets are collected from a stack of sheets by means of some type of feeder device which individually feeds the sheets to a centring device where the sheets are accurately positionally fixed and from whence they are subsequently fed into the press. On condition that the position of the sheet stack is accurately known, the sheets can possibly be fed straight into the press. Given that increasing mechanisation is taking place, it has been possible to increase the capacity of the press or the press line considerably in recent years. This implies that a feeding rate of 30 workpieces/min is desirable, a level which today's technology cannot meet using two picking stations.

Many press lines are obsolescent but have been gradually modernised. This often entails that the space ahead of the first press or between adjacent presses is extremely small, since presses were previously fed manually.

A type of feeder device, the so-called dip feeder, displays a pattern of movement which implies that each end of a rectilinear movement is downwardly directed.

In order to realise such a pattern of movement, complex mechanics are required with large, moving masses, from which it follows that the maximum workrate will be limited in the extreme. Consequently, a dip feeder cannot be used when the requirement on capacity exceeds 15/20 workpieces/min. If instead two dip feeders are employed which alternatingly take sheets from a stack, there will be a break in the feeding operation when the stack is consumed and must thus be replaced by a new stack. Such a production stoppage in a long, mechanised production line cannot be accepted.

It has also been proposed that an industrial robot be employed for the feeding of metal sheets. In order to meet the above-mentioned workrate without stoppage on the replenishment of the sheet stack, four robots would be required, which in turn requires a large space, entailing that the robots, for this reason alone, are unusable in most cases. In addition, the costs involved will be prohibitively high.

### OUTLINE OF THE INVENTION

The present invention has for its object to design the feeder device intimated by way of introduction, the feeder station intimated by way of introduction, and also the method intimated by way of introduction such that sufficient capacity is attained, that the requirement on small space needs can be met and that continuous operation can be carried out for lengthy periods of time, as well as that equipment employed can stand on the floor and costs can be kept within an acceptable ceiling.

The objects forming the basis of the present invention with respect to the feeder device will be attained if this is given the characterising features as set forth in appended claim 1.

These characterising features afford the advantage that a high capacity is achieved in that both of the arms can operate alternatingly, small spaces needs in that both of the arms pivot about a common axis, continuous operation in that the arms may be employed for the alternating picking of sheets from two different stacks, and finally that the device may readily be placed on the workshop floor.

The objects forming the basis of the present invention with respect to the feeder station will be attained if this is given the characterising features as set forth in appended claim 10.

As a result, the major advantage will be afforded that a feeder station is realised with high capacity since it operates alternatingly to one and the same sheet stack, space needs will be small since both gripping member pivot about a common axis, and continuous operation can be attained in that two stacks can be processed alternatingly.

The objects forming the basis of the present invention with respect to the method will be attained if this is given the characterising features as set forth in appended claim 12.

These characterising features afford the advantage of great rapidity by the alternating employment of the two gripping members, the requirement on small space needs will be met by the concentric pivoting of the gripping members and continuous operation will be attained by the alternating processing of two different stacks.

### BRIEF DESCRIPTION OF THE ACCOMPANYING DRAWINGS

The present invention will now be described in greater detail hereinbelow, with reference to the accompanying Drawings. In the accompanying Drawings:

FIG. 1 is a vertical side elevation of a feeder device according to the present invention;

FIG. 2 is a vertical front elevation of a feeder station according to the present invention, the greater part of the frame and similar components having been omitted for purposes of clarity; and

FIG. 3 shows from above and highly schematically a part of the feeder station according to FIG. 2.

### DESCRIPTION OF PREFERRED EMBODIMENT

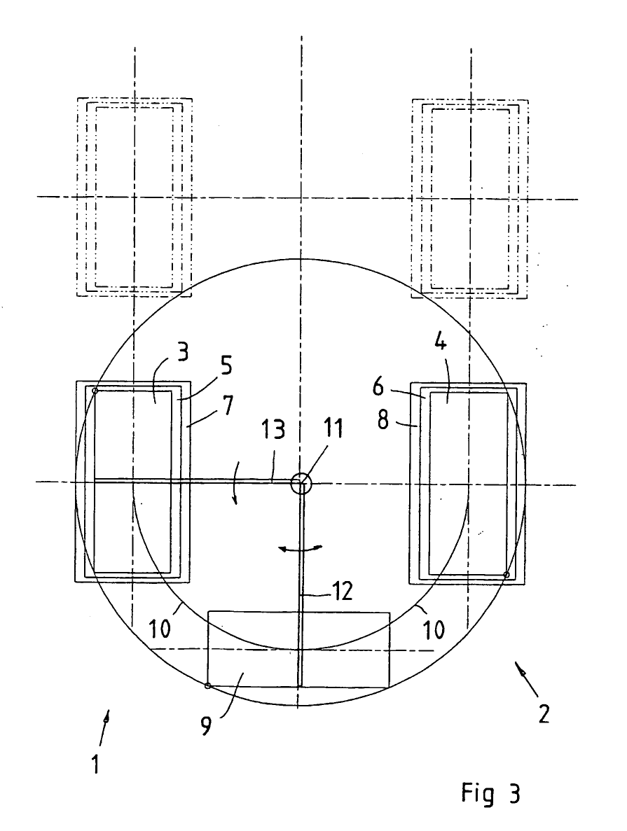

FIG. 3 shows a feeder station schematically from above. The station includes a first 1 and a second 2 stack of metal sheets 3 and 4, respectively. The sheet stacks 1 and 2 rest on pallets 5 and 6, respectively, which in turn rest on lifting tables 7 and 8, respectively. The lifting tables are arranged in such a manner that they gradually lift the sheet stacks 1 and 2 as these are consumed so that the height level of the uppermost sheet in each stack is always substantially constant.

The sheets 3 and 4 on the sheet stacks 1 and 2, respectively, are to be fed individually to a deposition site 9 which is at the same height level at the level of the uppermost sheets 3 and 4, respectively. The sheet stacks 1 and 2, as well as the deposition site 9, are arranged along a common arc of a circle 10 where, in the illustrated embodiment, they have a 90° distribution. The centre of this arc of a circle carries reference numeral 11.

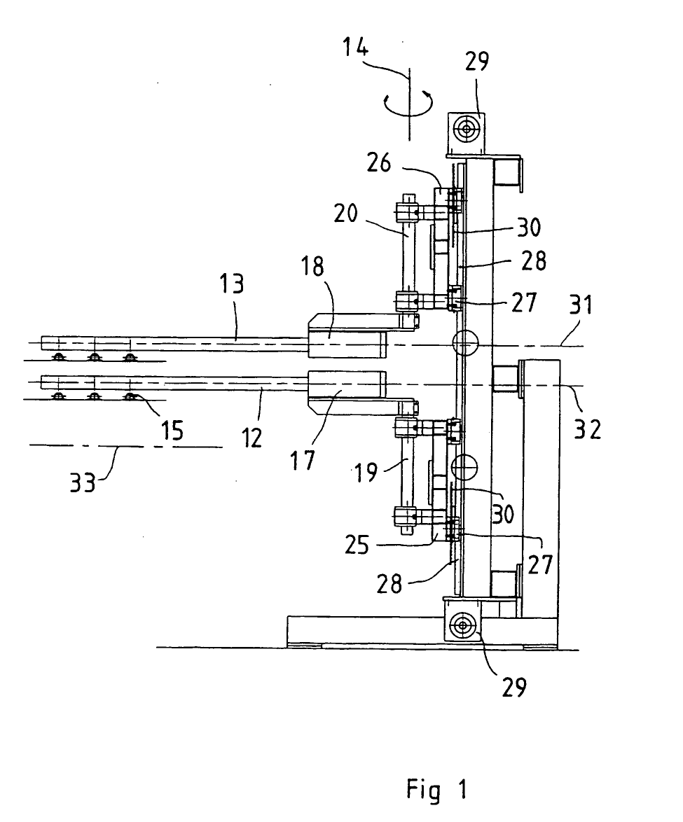

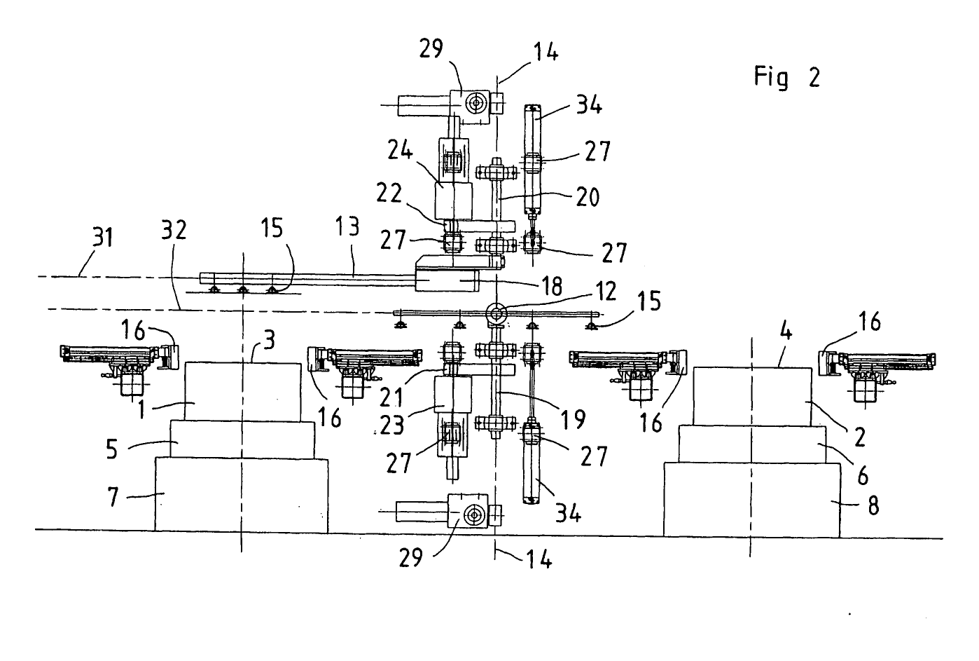

In the region of the centre 11 of the arc of a circle 10, there is disposed a movement device which will be described in greater detail below with reference to FIGS. 1 and 2, and which has a first or lower pivotal arm 12 and a second or upper pivotal arm 13 which are provided with gripping members (not shown in FIG. 3) for gripping and fixedly retaining the sheets. Both of the pivotal arms 12 and 13 have a common pivot axis 14 (FIGS. 1 and 2) which also coincides with a substantially vertical line through the centre 11 of the arc of a circle 10.

Both of the pivotal arms 12 and 13 are movable in the vertical direction along a vertical line which coincides with the pivot axis 14 through the centre point 11. In such instance, the first arm 12 is movable in the vertical direction from a deposition level for depositing a sheet on the deposition site 9, the level 33 also coinciding with a level 33 for picking a sheet at either of the two stacks 1 and 2. From this lower level, the arm is movable in an upward direction to a highest level 32. Correspondingly, the second arm 13 is movable from a pick-up or deposition level 33 for picking a sheet and for depositing it at the deposition site 9. This picking or deposition level coincides with a corresponding level for the first pivotal arm. In the vertical direction, the second arm is movable to a highest level 31 which is located above the highest level of the first arm 12. By raising the second arm 13 to its highest level, the arms can be pivoting past one another also when a sheet is secured in the gripping members 15 disposed on the arms.

On operation of the feeder station, it may be assumed that the first arm 12 is located in its deposition level at the deposition site 9 and that the second arm 13 is located in the picking position at the stack 1. When the first arm has deposited its sheet and the second arm has grasped a new sheet, both of the arms are raised to their respective highest levels 32 and 31. When the lifting operation is completed so far that the sheets are free of the stacks 1 and 2 and peripheral equipment such as separators 16, a pivotal movement may be commenced for both arms in opposite directions. Alternatively, the pivotal movement may be initiated only when both arms 12 and 13 have reached their respective highest levels. After completed pivoting through 90° in opposite directions, the arms have changed place so that the second arm is located above the deposition site 9 while the first arm is located over the stack 1. Thereafter, the arms are lowered to their lower deposition-or picking levels and the cycle is repeated.

When, for example, the first stack 1 is consumed, the arms 12 and 13 are pivoted to the second stack 2 for feeding sheets from this stack to the deposition site. During the time this feeding takes place from the second stack, the first stack is replenished, for which reason no operational stoppage need be feared when the stack is replenished. Once the second stack 2 has also been consumed, the arms 12 and 13 are pivoted back in order to feed sheets from the stack 1 to the deposition site 9, during which time the second stack 2 is replenished. As a result of the alternating cooperation of the arms 12 and 13 with the stack 1 and the stack 2, respectively, the possibility for continuous operation is thus offered.

In one practical version, the deposition site 9 may consist of a centring device where the individual sheets are accurately positioned at known positions in order thereafter to be transported to a press tool in a press line.

If the position of the two stacks 1 and 2 is accurately defined, the sheets deposited at the deposition site 9 can, in an alternative version, be transported directly further to a press.

FIG. 2 shows the feeder station according to FIG. 3 in slightly greater detail. In this Figure, the vertical line which passes through the centre 11 of the arc of a circle 10 has been given reference numeral 14. Both arms 11 and 12 are shown in the same positions as in FIG. 3. It will farther be apparent that, at the free ends of the arms 12 and 13, there is disposed a frame or so-called headpiece which is provided with a number of gripping members 15 which, in the illustrated embodiment, consist of suction cups of rubber. In the Figure, both of the arms 12 and 13 are also shown in their respective highest positions 32 and 31, respectively.

It will be apparent from the Figure that sheet separators 16 are disposed adjacent the two stacks 1 and 2 and serve the purpose of preventing more than one sheet at a time from being grasped by the gripping members 15. It will further be apparent that the sheet separators prevent an unduly early commencement of the pivotal movements of the two arms, since, in such a case, the grasped sheet would otherwise come into contact with the separators and either wholly let go from the gripping members or at least be positionally offset in an unacceptable manner.

It will be apparent from FIGS. 1 and 2 taken together that the arms 12 and 13 are, via quick couplings 17 and 18, respectively, each connected to their pivotal shaft or rod 19, 20, respectively. The shafts 19 are 20 are connected, by the intermediary of belt transmissions 21 and 22, respectively, each to their drive motor 23 and 24, respectively, for the pivotal movements of the arms 12 and 13. The shafts 19 and 20 have the vertical pivot axis 14 through the centre 11 of the arc of the circle 10 as their centre line.

The drive motors 23 and 24, the belt transmissions 21 and 22, as well as the shafts 19 and 20 are each disposed on their carrier device 25 and 26, respectively (FIG. 1). The carrier devices display four roller units 27 each, which are movable in a vertical direction along mutually parallel guide rails 28. The carrier devices 25 and 26 are movable in the vertical direction along the guide rails 28 by means of drive motors 29 and belt transmissions 30. In FIG. 1, reference numeral 31 relates to the highest level that the second arm 13 can assume, while reference numeral 32 relates to the highest level that the first arm 12 can assume. Reference numeral 33 relates to the common, lower level for both arms 12 and 13 and coincides with the level for picking a sheet from the stacks 1 or 2 and for depositing a sheet at the deposition site 9.

It will be apparent from FIG. 1 that the movement area of the second arm 13 is approximately twice as large as the movement area of the lower arm 12. As a result, if synchronous operation is to be possible, the second arm 13 must move in the vertical direction approximately twice as quickly as the lower arm and consequently also undergo approximately twice as great acceleration. In one practical embodiment, the distance between the uppermost level 31 and the lowermost level 33 is of the order of magnitude of half a metre. If the device according to the present invention, when the distance is, for example, 475 mm, is to be able to maintain a feeding rate of 30 sheets/min, a complete vertical movement travel for the upper arm 13 must not take more time than 0.5 sec. with 0.25 sec. acceleration and 0.25 sec. retardation. The maximum vertical speed will be 1.9 m/s, while the acceleration is 7.6 m/s². Since the moving masses are considerable (approx. 275 kg including carried sheet), it is possible—in order to reduce the power requirements in the two motors 29—to employ balancing cylinders 34 for balancing the effects of gravity on these masses so that the drive motors only need cater for the inertia forces.

According to the present invention, it is not necessary that the distribution angles between the stacks 1 and 2 and the deposition site 9 be exactly 90°. Thus, it is, for example in particularly cramped spaces, possible to reduce these angles, perhaps as far as 75°, depending on the dimensions of the sheets in relation to the arm length.

Nor is it necessary that the angles be equal if other circumstances concerning lay-out were to so require.

In a further alternative, the angles may be greater than 90°, even as much as 110°.

The only requirement on the position of the stacks and the deposition site 9 is that they must lie on a common arc of a circle.

In yet a further modified embodiment, the pivot axis 20 for the upper arm 13 may be turned to face downwards and thus be arranged in the same manner as the lower 19. In a further alternative, the lower pivot axis 19 may be cylindrical and at least partly surround the upper axis 20.

Regarding the stacks 1 and 2 and the deposition site 9, it was disclosed earlier that, in the vertical direction, they are disposed on the same level 33. This is a practical measure and facilitates programming of the control unit of the subject matter of the present invention. However, it is not necessary, but the stacks 1 and 2 and the deposition site 9 may instead be disposed at different levels, two on the same level, or all on three different levels.

1. A device for the continuous and individual feeding of metal sheets from a stack of sheets to a deposition site, and comprising a movement device for displacement of gripping members which are designed to individually grasp and hold the sheets, between the sheet stack and the deposition site, and back, wherein the movement device has a first and a second arm provided with the gripping members, said arms extending out from and being pivotal about a common, substantially vertical pivot axis; and that the arms are movable therealong in the vertical direction to positions for depositing a sheet, to positions for picking a sheet, and to positions where the one arm may be pivoted past over the other.

2. The device as claimed in claim 1, wherein the first arm is a lower arm, while the second arm is an upper arm; that the upper arm has a larger vertical area of movement than the lower; and that the upper arm has a highest position which is located higher than the highest position of the lower arm.

3. The device as claimed in claim 1 wherein the arms are of equal length and have their gripping members placed in the same manner.

4. The device as claimed in claim 1, wherein the arms are secured each in their rotary rod or shaft which are coaxial with one another and with the pivot axis, and also disposed the one over the other, the shafts each being journalled in a carrier device movable in the vertical direction along a guide.

5. The device as claimed in claim 4, wherein a drive motor for pivoting the shafts is disposed on each carrier device.

6. The device as claimed in claim 4, wherein the guide includes mutually parallel guide rails, along which roller units may be run on the carrier devices.

7. The device as claimed in claim 4, wherein the carrier devices are carried by and drivable under the action of a motorised toothed belt arrangement.

8. The device as claimed in claim 4, wherein the carrier devices are connected to balancing means for balancing at least a part of their weight.

9. The device as claimed in claim 1, wherein the arms are reciprocally pivotal within a sector of at least 90°, but preferably 180°.

10. A feeder station for continuous and individual discharging of sheets, comprising two stacks of sheets which are to be fed, a deposition site for sheets and a feeder device for the individual picking of sheets and deposition thereof at the deposition site, wherein the sheet stacks and the deposition site are disposed on a common arc of a circle; and that the feeder device has an arm provided with gripping members and disposed to transfer, alternatingly from the one or the other stack of sheets to the deposition site and that the arm being pivotal about a substantially vertical line through the center point of the arc of a circle.

11. A method of continuous and individual feeding of sheets from a stack of sheets to a deposition site, use being made of a movement device by means of which gripping members designed for the individual grasping and holding of the sheets, displace them from the stack to the deposition site, wherein a first and a second gripping member are pivoted about a common pivot axis and are vertically displaced therealong so that:
the first gripping member discharges a first sheet on the deposition site and the second gripping member grasps a second sheet on the stack;
the first gripping member is lifted to a first level and the second gripping member is lifted to a second level higher than the first;
the first and the second gripping members are pivoted in opposite directions so the second passes over the first;
the first and the second gripping members are lowered for picking a third sheet from the stack and depositing the second sheet on the deposition site, respectively;
the first and second gripping members are lifted to the first and second levels, respectively;
the first and the second gripping members are pivoted in opposite directions so that the second passes over the first; and
the first and the second gripping members are lowered for depositing the third sheet on the deposition site and for picking a fourth sheet from the stack, respectively, and so on.

12. The method as claimed in claim 11, wherein the gripping members are reciprocally pivoted between the first stack and the deposition site until the first stack is consumed and then reciprocally between the second stack and the deposition site, while the first stack is replenished.
